(19) United States
(12) Patent Application Publication
(10) Pub. No.: US 2025/0237429 A1
(43) Pub. Date: Jul. 24, 2025

(54) HOUSEHOLD REFRIGERATION APPLIANCE WITH AN ICE AND/OR WATER DISPENSER APPARATUS WITH SPECIFIC PRESSURE ADJUSTMENT FOR THE WATER, AND METHOD FOR OPERATING A HOUSEHOLD REFRIGERATION APPLIANCE

(71) Applicant: BSH Hausgeräte GmbH, München (DE)

(72) Inventors: Florian MÖRTL, Neu-Ulm (DE); Richard MAIER, Herbrechtingen (DE); Mathias SIGL, Herbrechtingen (DE); Miroslav MANDRIK, Kosice (SK); Ondrej FINDORAK, Kosice (SK)

(21) Appl. No.: 19/022,332

(22) Filed: Jan. 15, 2025

(30) Foreign Application Priority Data
Jan. 18, 2024 (DE) 102024200462.6

(51) Int. Cl. F25D 29/00; F25D 23/12

(52) U.S. Cl. CPC F25D 29/00; F25D 23/126; F25D 2600/06

(57) ABSTRACT

A household refrigeration appliance includes an ice and/or water dispenser apparatus for dispensing water and/or ice. The ice and/or water dispenser apparatus has at least one electronically controlled valve, which can be used to adjust the throughflow of water. A pressure reducer is disposed upstream of the electronically controlled valve in the flow direction of the water, and can be used to adjust the pressure of the water, as a result of which the water at an inlet of the electronically controlled valve has an entry pressure of less than 4 bar. A method for operating a household refrigeration appliance is also provided.

### CROSS-REFERENCE TO RELATED APPLICATION

This application claims the priority, under 35 U.S.C. § 119, of German Patent Application DE 10 2024 200 462.6, filed Jan. 18, 2024; the prior application is herewith incorporated by reference in its entirety.

### FIELD AND BACKGROUND OF THE INVENTION

One aspect of the invention relates to a household refrigeration appliance. The household refrigeration appliance has an ice and/or water dispenser apparatus for dispensing water and/or ice. A further aspect of the invention relates to a method for operating a household refrigeration appliance.

There are many different known configurations of household refrigeration appliances for storing and conserving food. Appliances are also known that additionally feature an ice and/or water dispenser apparatus. That allows liquid, in particular water, and/or ice to be dispensed as required and desired at an outlet of the household refrigeration appliance. Such household refrigeration appliances are connected to an external water supply network for that purpose. Water is supplied to the appliance by way of such an external water supply network. Conveyance of the water from the external water supply network to the household refrigeration appliance in that case is subject to the relevant local conditions. As a result, such a supply of water from outside the household refrigeration appliance to the household refrigeration appliance is also subject to different water pressure conditions. It is also known that very high water pressure can sometimes be present in the external water supply network, reaching up to around 10 bar or higher, for example in Scandinavia. Provision is therefore also made to reduce such pressures and corresponding measures are taken for that purpose.

Irrespective of the matter of different and/or excessively high pressures that may occur externally in the supplied water, different pressures can also be present in the water circulating in the household refrigeration appliance itself. That can also result for example in unwanted background noise during the dispensing of media such as water and/or ice.

### SUMMARY OF THE INVENTION

It is accordingly an object of the invention to provide a household refrigeration appliance with an ice and/or water dispenser apparatus with specific pressure adjustment for the water, and a method for operating such a household refrigeration appliance, which overcome the hereinafore-mentioned disadvantages of the heretofore-known appliances and methods of this general type and with which the background noise in the household refrigeration appliance is reduced when conveying media in the household refrigeration appliance.

This object is achieved by a household refrigeration appliance and a method according to the independent claims.

With the foregoing and other objects in view there is provided, in accordance with one aspect of the invention, a household refrigeration appliance. The household refrigeration appliance can be a refrigerator or a freezer or a combined refrigerator/freezer appliance. The household refrigeration appliance is configured in the intended manner to store and conserve food. The household refrigeration appliance has an ice and/or water dispenser apparatus. This is configured in the intended manner to dispense water and/or ice. The ice and/or water dispenser apparatus has at least one electronically controlled valve, which can be used to adjust the throughflow of water. The electronically controlled valve therefore in particular allows or blocks the water flow. A pressure reducer is disposed before the electronically controlled valve in the flow direction of the water provided for the ice and/or water dispenser apparatus in the household refrigeration appliance. The pressure reducer is therefore disposed upstream of the electronically controlled valve in the water circuit of the household refrigeration appliance. The pressure reducer is set up in the intended manner to adjust the pressure of the water in the household refrigeration appliance, so that the water at an inlet of the electronically controlled valve has an entry pressure of less than 4 bar.

With such a household refrigeration appliance it is now possible to adjust the pressure of the water flowing in the household refrigeration appliance itself, the water being provided in the intended manner to supply the ice and/or water dispenser apparatus, in a very specific manner to a correspondingly lower value. Of particular advantage here is the position of the pressure reducer, this being before the electronically controlled valve. In a particularly advantageous and surprising manner this position and the setting of the specific entry pressure of less than 4 bar allow a significant reduction of the background noise during operation of the household refrigeration appliance, in particular specifically during the dispensing of water using the ice and/or water dispenser apparatus and/or during the supplying of water to produce ice in the ice and/or water dispenser apparatus. Such a configuration particularly advantageously allows a reduction in sound pressure greater than 15 db(A) to be achieved. In particular reductions in sound pressure of around 20 db(A) can be achieved. This significantly reduces background noise. A user in the room where the household refrigeration appliance is located, who wants a quieter environment, is no longer disturbed or adversely affected for example when holding a conversation and/or making a telephone call or wishing to engage acoustically with other information sources, such as a radio or TV. Also during the night when ice is produced or is to be produced automatically in this way, the background noise is significantly reduced when water is supplied for this purpose to an ice production unit of the ice and/or water dispenser apparatus in the household refrigeration appliance itself.

In one exemplary embodiment the pressure of the water is adjusted using the pressure reducer so that water at the inlet of the electronically controlled valve has an entry pressure of less than 3 bar, in particular an entry pressure between 1.5 bar and 2.5 bar. It is then possible to set relatively low pressures in a defined and desired manner, resulting, in combination with the position of the pressure reducer in the water conveying system of the household refrigeration appliance as a whole, in the significant reduction in background noise.

In one exemplary embodiment the household refrigeration appliance has a line, by way of which the household refrigeration appliance, in particular the ice and/or water dispenser apparatus, is connected to a fixed water connection outside the appliance. The pressure reducer is preferably disposed in the line. Such specific positioning on the one hand results in a compact arrangement. On the other hand in one exemplary embodiment the water pressure can also be correspondingly reduced at the inlet of the household refrigeration appliance.

In one exemplary embodiment the pressure reducer is a separate part from the line. This allows the pressure reducer to be replaced separately.

In another exemplary embodiment the pressure reducer can be integrated in the line. Such an, in particular single-piece, configuration of the pressure reducer and line means fewer parts are required. It also reduces assembly outlay. In particular any leaks at the interface between the pressure reducer and the connection points to the line are permanently avoided.

In another exemplary embodiment the pressure reducer is disposed in the ice and/or water dispenser apparatus. It is therefore incorporated entirely within this. Pressure fluctuations at the inlet of the electronically controlled valve can therefore be more easily avoided, as the distances between the pressure reducer and the inlet of the electronically controlled valve are minimized.

In one exemplary embodiment the household refrigeration appliance, in particular the ice and/or water dispenser apparatus, has at least one further valve. This is a separate valve from the above-mentioned electronically controlled valve. It is possible for the further valve not to be an electronically controlled valve. In particular it can be a mechanical non-return valve. In one exemplary embodiment the pressure reducer can be incorporated in the non-return valve. Such mechanically operating non-return valves do not have the above-mentioned noise problem when operating. It is a problem in particular for electronically controlled valves however. A humming that occurs by way of an example of background noise during operation of such an electronically controlled valve does not occur with such mechanical non-return valves. It is therefore also important, for household appliances with such electronically controlled valves specifically incorporated in their ice and/or water dispenser apparatuses, to reduce the associated background noise when the valve is actuated or operates.

It is therefore also advantageous to incorporate such a mechanically operating non-return valve at points in the household refrigeration appliance, where such an electronically controlled valve is not required. This also reduces background noise, as such use of different types of valve reduces the number of electronically controlled valves. As explained in the above-mentioned advantageous exemplary embodiment, such a valve can then also serve in the manner of a support unit for the pressure reducer.

In one exemplary embodiment the ice and/or water dispenser apparatus has at least two electronically controlled valves. These can be used to adjust the throughflow of water in the line system of the household refrigeration appliance itself in a defined manner. The pressure reducer can be used to adjust the pressure of the water for both electronically controlled valves. In particular it allows the water at respective inlets of the at least two separate electronically controlled valves to have an entry pressure of less than 3 bar, in particular between 1.5 bar and 2.5 bar. In particular the entry pressure is set at the corresponding cited value. This very advantageously allows a number of separate such electronically controlled valves in the household refrigeration appliance, which are associated functionally with the line system for conveying water for the ice and/or water dispenser apparatus, to be adjusted together using a single such pressure reducer.

In one exemplary embodiment the electronically controlled valve is a solenoid valve. This can be adjusted in a particularly individual and finely graduated manner, allowing very precise throughflow settings. Such valves can also be actuated very quickly, so the desired throughflow can also be adjusted very quickly.

In one exemplary embodiment the ice and/or water dispenser apparatus has an ice tray, to which water can be supplied with individual and defined control by the electronically controlled valve. The ice tray is part of the ice production unit of the ice and/or water dispenser apparatus. The water introduced into the ice tray is then frozen due to the temperature in the ice production unit. This produces ice, for example shaped ice elements, which may be ice cubes.

In one exemplary embodiment the ice and/or water dispenser apparatus has a water tank and a water filter. At least one electronically controlled valve of the household refrigeration appliance, in particular the ice and/or water dispenser apparatus, is disposed before the water filter and/or before the water tank in the flow direction of the water in the household refrigeration appliance. This also has structural advantages, on the one hand with regard to the compact and space-saving structure and on the other hand with regard to a positive effect in reducing background noise.

In one exemplary embodiment the ice and/or water dispenser apparatus has a water tank and a water filter, at least one electronically controlled valve being disposed after the water filter and/or after the water tank in the flow direction of the water in the household refrigeration appliance. This also has the above-mentioned advantageous effect. In particular it is also possible with this exemplary embodiment at least to reduce, in particular to prevent, any dripping of water from an outlet of the ice and/or water dispenser.

In accordance with the objects of the invention, a further independent aspect of the invention relates to a household refrigeration appliance with an ice and/or water dispenser apparatus. The household refrigeration appliance can be a refrigerator or a freezer or a combined refrigerator/freezer appliance. The household refrigeration appliance is configured in the intended manner to store and conserve food. The household refrigeration appliance has an ice and/or water dispenser apparatus. This is configured in the intended manner to dispense water and/or ice. The ice and/or water dispenser apparatus has at least one electronically controlled valve, which can be used to adjust the throughflow of water. A pressure reducer is disposed before the electronically controlled valve in the flow direction of the water provided for the ice and/or water dispenser apparatus in the household refrigeration appliance. The pressure reducer is therefore disposed upstream of the electronically controlled valve in the water circuit of the household refrigeration appliance.

The pressure reducer can be used, in particular is used, to adjust the pressure of the water at an inlet of the electronically controlled valve so that the operating noise of the electronically controlled valve is reduced compared with operation at a base pressure by a value of at least 17 db(A). In particular the operating noise or the sound pressure of the operating noise is reduced by a value of at least 18 db(A), in particular by a value of around 20 db(A). The base pressure in particular has a value greater than 4 bar, in particular greater than 5 bar.

Advantageous exemplary embodiments of the above-mentioned first independent aspect of the inventive household refrigeration appliance should be considered to be advantageous exemplary embodiments of the further independent aspect relating to a household refrigeration appliance.

With the objects of the invention in view there also provided, in accordance with a further aspect of the invention, a method for operating a household refrigeration appliance, in particular according to the above-mentioned aspect or an advantageous exemplary embodiment thereof. The method preferably has the following steps:
activating the ice and/or water dispenser apparatus of the household refrigeration appliance;
supplying water to the ice and/or water dispenser apparatus and metering the water flow using at least one electronically controlled valve of the household refrigeration appliance;
adjusting the pressure of the water using a pressure reducer of the household refrigeration appliance upstream of the electronically controlled valve so that water at an inlet of the electronically controlled valve has an entry pressure of less than 4 bar and/or operating noise of the electronically controlled valve is reduced by a value of at least 17 db(A) compared with operation at a base pressure.

Advantageous exemplary embodiments of the above-mentioned aspects relating to a household refrigeration appliance should be considered to be advantageous exemplary embodiments of the method. The specific components of the household refrigeration appliance, alone or in conjunction with one another, therefore allow the performance of corresponding method steps. In particular a control unit of the household refrigeration appliance can be provided here to control these processes.

Other features which are considered as characteristic for the invention are set forth in the appended claims.

Although the invention is illustrated and described herein as embodied in a household refrigeration appliance with an ice and/or water dispenser apparatus with specific pressure adjustment for the water, and a method for operating a household refrigeration appliance, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a schematic circuit diagram of an exemplary embodiment of an inventive household refrigeration appliance, which is connected to an external water supply network; and

FIG. 2 is a schematic circuit diagram of a further exemplary embodiment of an inventive household refrigeration appliance, which is connected to an external water supply network.

### DETAILED DESCRIPTION OF THE INVENTION

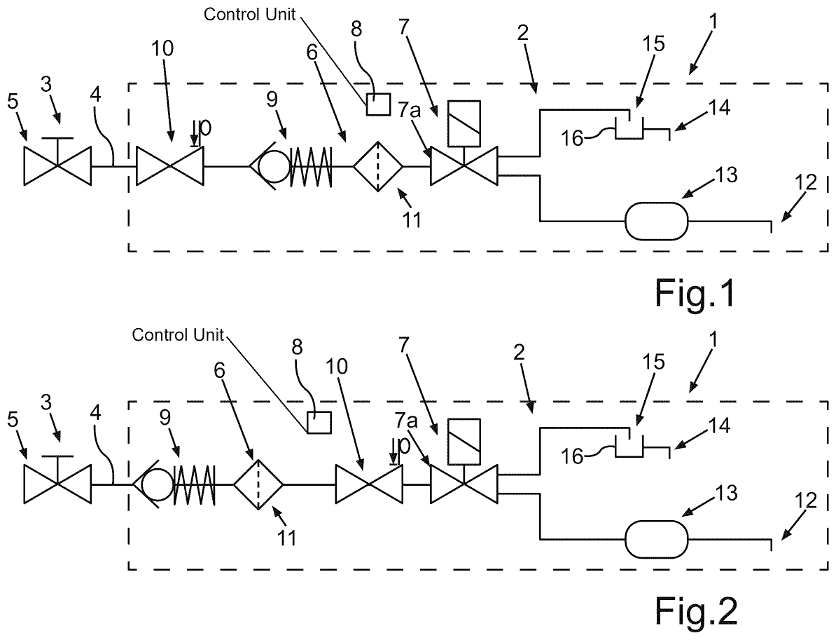

Referring now in detail to the figures of the drawings, in which identical elements or those of identical function are shown with identical reference characters, and first, particularly, to FIG. 1 thereof, there is seen a schematic diagram of an exemplary embodiment of a household refrigeration appliance 1. The household refrigeration appliance 1 is configured to store and conserve food. It is provided to do so in the intended manner. The household refrigeration appliance 1 generally has a housing, in which at least one holding space for food is configured. This holding space can be a chiller compartment or a freezer compartment. The household refrigeration appliance 1 also has a door, which is disposed in a movable manner on the housing to close or open the holding space.

The household refrigeration appliance 1 also has an ice and/or water dispenser apparatus 2. This is incorporated in the household refrigeration appliance 1. The ice and/or water dispenser apparatus 2 is configured and provided in the intended manner to dispense water and/or ice.

In order to dispense water and/or ice the ice and/or water dispenser apparatus 2 requires water. In the exemplary embodiment this is supplied to the household refrigeration appliance 1 by way of an external water supply network 3. To this end the household refrigeration appliance 1 is connected by a line 4 to a fixed water connection 5 of the external water supply network 3.

A line system 6 is also provided in the household refrigeration appliance 1. The line system 6 conveys the water supplied from outside. The line system 6 can be part of the ice and/or water dispenser apparatus 2.

In another exemplary embodiment at least sub-elements of the line system 6 can be part of the ice and/or water dispenser apparatus 2. In the exemplary embodiment the line system 6 has at least one electronically controlled valve 7. In particular this is a solenoid valve. This electronically controlled valve 7 is connected in particular to a control unit 8 of the household refrigeration appliance 1 so that the valve 7 is controlled by the control unit 8.

A further valve 9 is also provided. In the exemplary embodiment this is a mechanical non-return valve. In the exemplary embodiment the further valve 9 is incorporated upstream of the electronically controlled valve 7 in the flow direction of the water in the line system 6.

The household refrigeration appliance 1 also has a pressure reducer 10. This can also be referred to as a pressure reducer unit. The pressure reducer 10 is disposed before or upstream of the electronically controlled valve 7 in the flow direction of the water in the line system 6. It is therefore incorporated upstream of the electronically controlled valve 7. In the exemplary embodiment shown the pressure reducer 10 is incorporated upstream of the further valve 9.

In the exemplary embodiment the household refrigeration appliance 1 also has a water filter 11. This is used to filter the water supplied from outside. The water filter 11 is disposed between the two valves 7 and 9 in this case. It is incorporated in particular upstream of the electronically controlled valve 7 and downstream of the further valve 9 in the line system 6.

The ice and/or water dispenser apparatus 2 has a water outlet 12, by way of which the water can be dispensed. In particular, a water tank 13 is also provided, from which the already filtered water is conveyed when water is to be dispensed. The ice and/or water dispenser apparatus 2 also has an ice outlet 14. The frozen shaped ice elements and/or crushed ice is/are dispensed from there.

The pressure reducer 10 is used to adjust the pressure of the water in the line system 6 in a defined manner. As a result the conveyed water has an entry pressure of less than 4 bar, in particular an entry pressure less than 3 bar, in particular an entry pressure less than 2.5 bar, in particular an entry pressure of around 2 bar at an inlet 7a of the electronically controlled valve 7. When the valve 7 is operating and when it is actuated for this purpose in particular by the control unit 8, to meter a water throughflow accordingly, the specific adjusted entry pressure and the position of the pressure reducer 10 upstream of the valve 7 also result in a reduction in the operating noise of the valve 7 of at least 17 db(A). This can be noted in particular in relation to a base pressure. The base pressure in this case is greater than or equal to 4 bar.

This also results in particular in a reduction in background noise, when water is introduced by way of a supply line 15 into an ice tray of an ice production unit 16 of the ice and/or water dispenser apparatus 2 to produce ice. In particular noise, which is the operating noise of the valve 7, and/or noise, which arises from the introducing and/or dispensing of liquid, in particular water, can be reduced significantly.

In another exemplary embodiment it is also possible for the pressure reducer 10 to be disposed outside the household refrigeration appliance 1 and to be disposed in the line 4 between the fixed water connection 5 and the household refrigeration appliance 1. It can be a separate component from the line 4 in this case too. In another exemplary embodiment it can be integrated in the line 4.

FIG. 2 shows a schematic diagram of a further exemplary embodiment of a household refrigeration appliance 1. In contrast to the embodiment shown in FIG. 1 the pressure reducer 10 in this case is connected directly before or upstream of the electronically controlled valve 7. In this example the further valve 9 that is preferably present and the water filter 11 are therefore disposed upstream of the pressure reducer 10 in the line system 6.

In the exemplary embodiments shown in FIG. 1 and FIG. 2 the pressure reducer 10 is separate from the further valve 9 that is preferably present.

In one exemplary embodiment provision can also be made for the pressure reducer 10 to be disposed in the further valve 9, in particular to be incorporated therein. The further valve 9 is a valve that operates mechanically.

The following is a summary list of reference numerals and the corresponding structure used in the above description of the invention:
1 Household refrigeration appliance
2 Ice and/or water dispenser apparatus
3 External water supply network
4 Line
5 Fixed water connection
6 Line system
7 Valve
7a Inlet
8 Control unit
9 Valve
10 Pressure reducer
11 Water filter
12 Water outlet
13 Water tank
14 Ice outlet
15 Supply line
16 Ice production unit

1. A household refrigeration appliance, comprising:
an ice and/or water dispenser apparatus for dispensing at least one of water or ice, said ice and/or water dispenser apparatus having at least one electronically controlled valve configured to adjust a throughflow of water, said at least one electronically controlled valve having an inlet; and
a pressure reducer disposed upstream of said electronically controlled valve in a flow direction of the water, said pressure reducer configured to adjust a pressure of the water, resulting in the water at said inlet of said at least one electronically controlled valve having an entry pressure of less than 4 bar.

2. The household refrigeration appliance according to claim 1, wherein said pressure reducer is configured to adjust the entry pressure of the water at said inlet of said at least one electronically controlled valve to less than 3 bar.

3. The household refrigeration appliance according to claim 1, wherein said pressure reducer is configured to adjust the entry pressure of the water at said inlet of said at least one electronically controlled valve to between 1.5 bar and 2.5 bar.

4. The household refrigeration appliance according to claim 1, which further comprises a line configured to connect the household refrigeration appliance to a fixed water connection outside the appliance, said pressure reducer being disposed in said line.

5. The household refrigeration appliance according to claim 1, which further comprises a line configured to connect said ice and/or water dispenser apparatus to a fixed water connection outside the appliance, said pressure reducer being disposed in said line.

6. The household refrigeration appliance according to claim 4, wherein said pressure reducer is a part separate from said line.

7. The household refrigeration appliance according to claim 5, wherein said pressure reducer is a part separate from said line.

8. The household refrigeration appliance according to claim 4, wherein said pressure reducer is integrated in said line.

9. The household refrigeration appliance according to claim 5, wherein said pressure reducer is integrated in said line.

10. The household refrigeration appliance according to claim 1, wherein said pressure reducer is disposed in said ice and/or water dispenser apparatus.

11. The household refrigeration appliance according to claim 1, which further comprises a further valve or mechanical non-return further valve, said pressure reducer being incorporated in said further valve or disposed upstream or downstream of said further valve.

12. The household refrigeration appliance according to claim 11, wherein said further valve is part of said ice and/or water dispenser apparatus.

13. The household refrigeration appliance according to claim 1, wherein:
said at least one electronically controlled valve of said ice and/or water dispenser apparatus includes at least two electronically controlled valves having inlets and being configured to adjust the throughflow of water; and
said pressure reducer is configured to adjust the pressure of the water for said at least two electronically controlled valves, resulting in the water at said inlets of said at least two electronically controlled valves having an entry pressure of less than 3 bar.

14. The household refrigeration appliance according to claim 1, wherein:
said at least one electronically controlled valve of said ice and/or water dispenser apparatus includes at least two electronically controlled valves having inlets and being configured to adjust the throughflow of water; and
said pressure reducer is configured to adjust the pressure of the water for said at least two electronically controlled valves, resulting in the water at said inlets of said at least two electronically controlled valves having an entry pressure of between 1.5 bar and 2.5 bar.

15. The household refrigeration appliance according to claim 1, wherein said at least one electronically controlled valve is a solenoid valve.

16. The household refrigeration appliance according to claim 1, wherein said ice and/or water dispenser apparatus has an ice production unit, and said at least one electronically controlled valve is configured to control water supplied into said ice production unit.

17. The household refrigeration appliance according to claim 1, wherein said ice and/or water dispenser apparatus has a water tank and a water filter, and said at least one electronically controlled valve is disposed at least one of upstream of said water filter or upstream of said water tank in the flow direction of the water.

18. The household refrigeration appliance according to claim 1, wherein said ice and/or water dispenser apparatus has a water tank and a water filter, and said at least one electronically controlled valve is disposed at least one of downstream of said water filter or downstream of said water tank in the flow direction of the water.

19. A household refrigeration appliance, comprising:
an ice and/or water dispenser apparatus for dispensing at least one of water or ice, said ice and/or water dispenser apparatus having at least one electronically controlled valve configured to adjust a throughflow of water, said at least one electronically controlled valve having an inlet; and
a pressure reducer disposed upstream of said at least one electronically controlled valve in a flow direction of the water, said pressure reducer configured to adjust a pressure of the water at said inlet of said at least one electronically controlled valve, causing at least an operating noise of said at least one electronically controlled valve to be reduced by a value of at least 17 db(A) compared with operation at a base pressure.

20. A method for operating a household refrigeration appliance, the method comprising:
providing the household refrigeration appliance according to claim 1;
activating said ice and/or water dispenser apparatus of the household refrigeration appliance;
supplying water to said ice and/or water dispenser apparatus and metering a water flow by using said at least one electronically controlled valve of the household refrigeration appliance;
adjusting the pressure of the water by using said pressure reducer of the household refrigeration appliance disposed upstream of said at least one electronically controlled valve, causing the water at the inlet of said at least one electronically controlled valve to have an entry pressure of less than 4 bar.
